(19) United States
(12) Patent Application Publication
(10) Pub. No.: US 2026/0367908 A1
(43) Pub. Date: Nov. 19, 2026

(54) AUTOMATED CONTINUOUS INFRASTRUCTURE MONITORING IN CI/CD ENVIRONMENT

(71) Applicant: SAP SE, Walldorf (DE)

(72) Inventors: Adrien ANCELIN, Thilouze (FR); Thomas COAN, Carrieres Sur Senine (FR)

(21) Appl. No.: 19/207,704

(22) Filed: May 14, 2025

(51) Int. Cl. G06F 8/71; G06F 8/60; G06F 11/30

(52) U.S. Cl. CPC G06F 8/71; G06F 8/60; G06F 11/302

(57) ABSTRACT

A cloud computing CI/CD environment may include a proposed software change data store containing electronic records associated with the CI/CD environment, and a forecast model with embedded logic may estimate an infrastructure impact. A continuous impact monitoring framework can then automatically and continuously identify proposed software changes based on information in the proposed software change data store. The continuous impact monitoring framework also automatically and continuously executes the embedded logic to calculate an infrastructure impact of a first proposed software change. If the infrastructure impact is positive, the system may automatically deploy the first proposed software change in the CI/CD environment. If the infrastructure impact is negative, the system may automatically block the first proposed software change from deployment in the CI/CD environment. In some embodiments, a reconciliation data store contains forecast information and invoice information associated with the first proposed software change.

### BACKGROUND

Continuous Integration and Continuous Deployment or Delivery (“CI/CD”) may provide for continuous integration to facilitate frequent merges of several small changes into a main branch. Continuous delivery may produce software in short cycles with high speed and frequency so that reliable software can be released at any time, and continuous deployment may allow for an automatic rollout of new software functionality in a cloud computing environment. CI/CD can help bridge gaps between development and operational activities and teams by enforcing automation in building, testing, and deployment of applications. For example, CI/CD services may compile incremental code changes made by developers and then link and package them into software deliverables. Automated tests may verify the software functionality, and automated deployment services can deliver them to end users. Goals include increasing early defect discovery, increasing productivity, and providing faster release cycles. The process contrasts with traditional methods where a collection of software updates were integrated into one large batch before deploying the newer version.

Software changes can, however, result in foreseen infrastructure impacts in a cloud computing environment. For example, a developer might make a small change that results in an unexpected increase in cloud provider costs (e.g., due to network transfer or backup storage). Note that managing infrastructure impacts (e.g., costs) in a cloud computing environment is inherently complex. For example, an enterprise may adopt a multi-cloud strategy and offer a Software-as-a-Service (“SaaS”) solution supported by hundreds of microservices managed in diverse teams across various countries and organizational units, and this complexity can escalate even further. For example, an enterprise may utilize a SaaS product hosted across more than 20 production and 20 development/test deployments within data centers. Impact tracking is generally conducted on a monthly basis by controllers, providing an overarching view of key spending categories, supporting profitability calculations, and highlighting impact surges.

However, several challenges have been identified in effectively managing and investigating these expenses. First, a delayed feedback loop may result in considerable time gaps between resource adjustments and the observable financial consequences. Reversing resource-sizing changes after they have been implemented can be operationally challenging or technically unfeasible. Second, fragmented expertise may result in developers who lack financial literacy regarding the infrastructure impact implications of their decisions, while financial controllers may lack the architectural and technical knowledge necessary to contextualize and validate infrastructure expenses. Third, there is a loss of granularity as data moves through multiple layers (e.g., hyperscaler billing and internal cloud reporting systems). Final aggregated figures often obscure the specific sources of expenditures.

Some vendors have proprietary suites of resource analysis and optimization, which are serviceable for small-scale operations in single-vendor, single-product setup. However, at a large scale, such tools fail to provide a comprehensive view, the added complexities of shared reserved instances, custom discount rules, multiple geo-regions, etc. and often render the data unintelligible. Access to these tools also typically requires permissions to the hyperscaler accounts (which are often restricted to specific personnel), and their complex nature demands substantial learning to derive global actionable insights. Some providers have developed solutions to reconcile multiple accounts across vendors within a unified interface. These tools cannot access the infrastructure's underlying business logic, and effective grouping and tagging of resources can enable ownership identification to facilitate both control and reconciliation. However, these solutions depend on standardized consumption practices, which may not apply universally. For instance, an internal Infrastructure-as-a-Service (“IaaS”) layer may introduce proprietary rules and cross-charging logic that external tools could not accommodate. These tools are also reactive, as they rely on observing existing resources. For impacts to be allocated or tagged, the resources must already exist. Thus, while they may expedite reaction times to problems, the tools are unable to prevent them.

It would therefore be desirable to provide infrastructure impact monitoring in a secure, automatic, and efficient manner. Moreover, improved processes, tools, and/or cross-functional collaboration may enhance impact visibility, streamline investigations, and/or foster more informed decision-making across technical and financial domains.

### SUMMARY

According to some embodiments, methods and systems associated with a CI/CD environment may include a proposed software change data store containing electronic records associated with the CI/CD environment, and a forecast model with embedded logic may estimate an infrastructure impact. A continuous impact monitoring framework can then automatically and continuously identify proposed software changes based on information in the proposed software change data store. The continuous impact monitoring framework also automatically and continuously executes the embedded logic to calculate an infrastructure impact of a first proposed software change. If the infrastructure impact is positive, the system may automatically deploy the first proposed software change in the CI/CD environment. If the infrastructure impact is negative, the system may automatically block the first proposed software change from deployment in the CI/CD environment. In some embodiments, a reconciliation data store contains forecast information and invoice information associated with the first proposed software change.

Some embodiments comprise: means for automatically and continuously identifying, by a computer processor of a continuous impact monitoring framework, proposed software changes based on information in a proposed software change data store; means for automatically and continuously executing embedded logic of a forecast model to calculate an infrastructure impact of a first proposed software change; if the infrastructure impact is positive, means for automatically deploying the first proposed software change in the CI/CD environment; and if the infrastructure impact is negative, means for automatically blocking the first proposed software change from deployment in the CI/CD environment.

Some technical advantages of some embodiments disclosed herein are improved systems and methods to provide infrastructure impact monitoring in a secure, automatic, and efficient manner.

### BRIEF DESCRIPTION OF THE DRAWINGS

FIG. 1 illustrates a delayed feedback loop for a change implemented in a typical in a CI/CD environment.

FIG. 2 illustrates fragmented expertise associated with a typical CI/CD environment.

FIG. 3 illustrates impact granularity loss in a typical CI/CD environment.

FIG. 4 is a high-level system architecture associated with a CI/CD environment in accordance with some embodiments.

FIG. 5 is a continuous impact monitoring method according to some embodiments.

FIG. 6 is a pipeline in accordance with some embodiments.

FIG. 7 is an infrastructure impact calculation for CI/CD changes according to some embodiments.

FIG. 8 illustrates a change implemented in a CI/CD environment in accordance with some embodiments.

FIG. 9 is a control stage table according to some embodiments.

FIG. 10 is a control stage date chart in accordance with some embodiments.

FIG. 11 is a control stage function chart according to some embodiments.

FIG. 12 includes reconciliation stage tables in accordance with some embodiments.

FIG. 13 is an apparatus or platform according to some embodiments.

FIG. 14 is a portion of a control data store in accordance with some embodiments.

FIG. 15 is a portion of a reconciliation data store in accordance with some embodiments.

FIG. 16 illustrates a tablet computer associated with continuous impact monitoring according to some embodiments.

FIG. 17 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

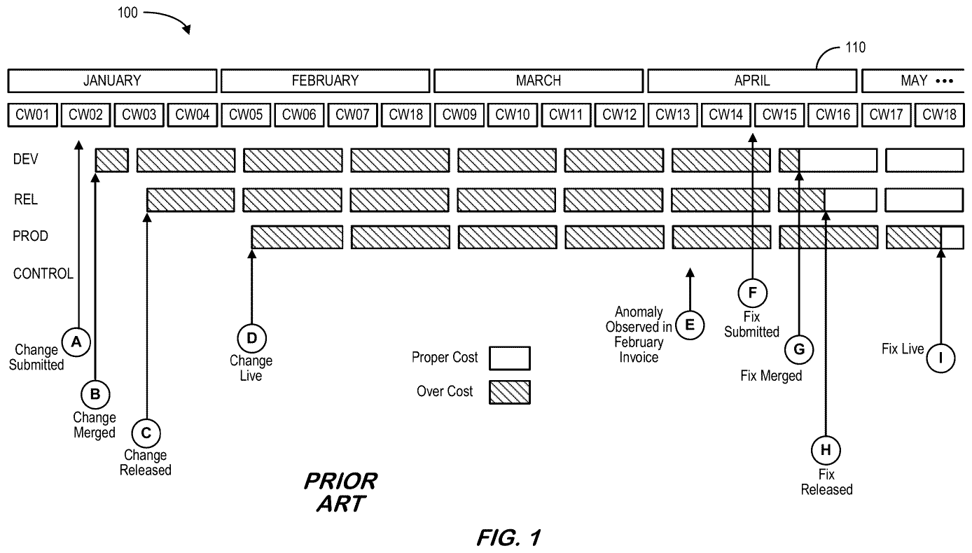

FIG. 1 illustrates a delayed feedback loop for a software change implemented in a typical in a CI/CD environment 100. A multi-Calendar Week (“CW”) timeline 110 may include, for example, software development, release, production, and control processes. At (A), a potential software change is submitted by a developer. At (B), the change is merged in the development process. In this example, the developer's change results in an unexpected increase in the development process from a proper cost to an over cost (shown as cross-hatched in FIG. 1). At (C), the change is released and (since the release includes the change) the process also has an over cost. At (D), the change is deployed and the production process now also results in an over cost.

Sometime later, an over cost anomaly (due to the software change) is observed in an earlier invoice at (E). Once the problem is investigated and identified, at (F) a fix is submitted to address the unexpected over charge is submitted by the developer. Eventually, the fix is merged into the software at (G) (resulting in the over charge going away for the development process), the fix is released at (H) (resulting in the over charge going away for the release process), and the fix is released at (I) (resulting in the over charge going away for the production process). Although the over charge is identified and addressed, the lag between the introduction of the problem and the resolution can result in substantial costs to the enterprise.

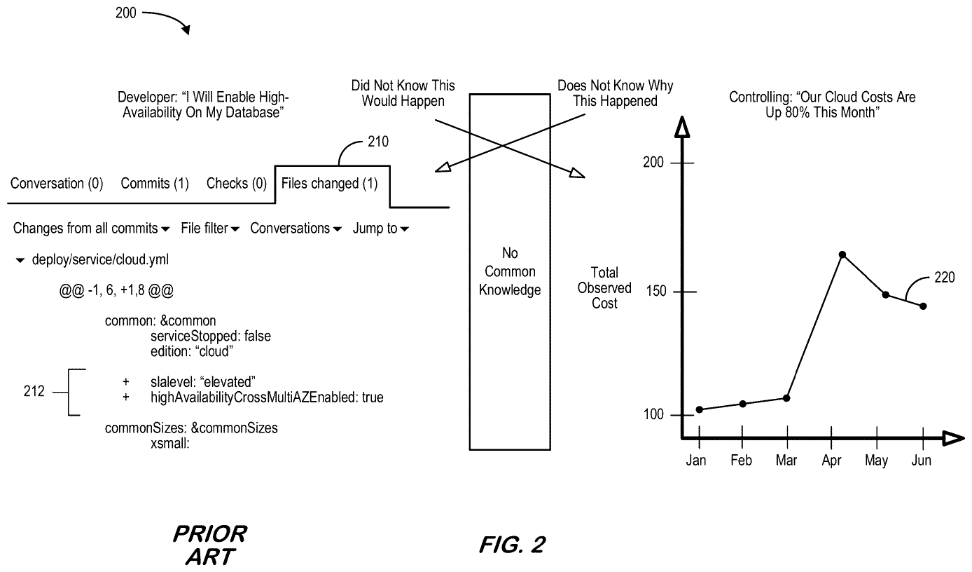

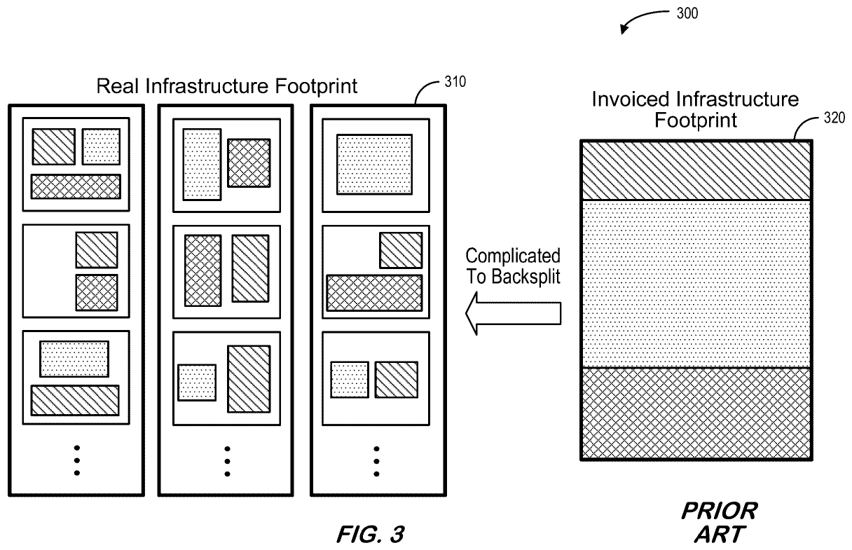

FIG. 2 illustrates fragmented expertise 200 associated with a typical CI/CD environment. In particular, a developer introduces a change 212 to software 210 (e.g., adjusting a service level agreement for database high availability). As a result of the change 212, observed costs 220 may unintentionally increase. This is due to a lack of common knowledge between developers (who may not comprehend the impact of software changes) and an enterprise cost control process (which may not understand why costs 220 have suddenly increased). FIG. 3 illustrates infrastructure impact granularity loss 300 in a typical CI/CD environment. Here, a real infrastructure footprint 310 may result in an aggregated invoice infrastructure footprint 320. In FIG. 3 the various crosshatches might represent, for example, database size, cloud computing resources, storage (e.g., hot, cold, and warm), etc. Deriving the actual infrastructure footprint 310 from the invoiced infrastructure footprint 320 received from a cloud service provider can be a difficult (if not impossible), time-consuming and error-prone task. At small scales, public documentation and vendor estimation tools may be utilized to address some of these issues. However, in a multi-vendor, multi-region, multi-service environment, the absence of unified estimation Application Programing Interfaces (“APIs”) makes such processes impractical to systematize.

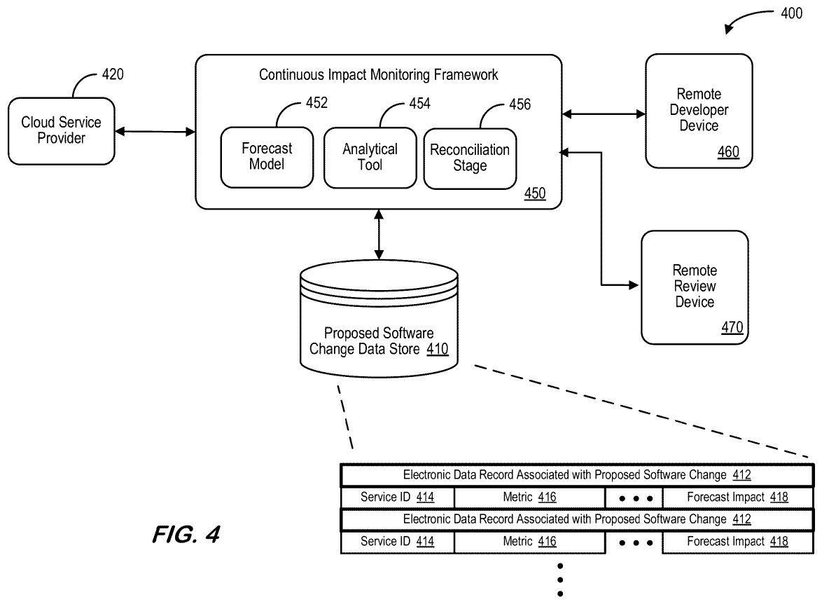

Some embodiments described here integrate financial operation forecasting practices into continuous pipelines to address such problems preemptively. FIG. 4 is a high-level system architecture associated with a CI/CD environment in accordance with some embodiments. In particular, the system 400 includes a continuous impact monitoring framework 450 that may access information in a proposed software change data store 410 that associated with software being developed and/or modified (e.g., a set of electronic records associated with changes 412, each record including, for example, one or more service identifiers 414, appropriate metrics 416, forecast impact or cost values 418, etc.). The continuous impact monitoring framework 450 may also store information into other data stores, such as an invoice data store 420 containing information about cloud provider costs 420, and utilize a forecast model 452, analytical tool, 454, and reconciliation stage 456 to view, analyze, and/or update electronic records. The continuous impact monitoring framework 450 may also exchange information with a remote developer device 460 and a remote review device 470 (e.g., via a firewall). According to some embodiments, an interactive Graphical User Interface (“GUI”) platform of the continuous impact monitoring framework 450 may facilitate the creation and review of code change analysis, recommendations, alerts, and/or the display of results via one or more administrator computers (e.g., to summarize system 400 performance) and/or the remote devices 460, 470. For example, the remote developer device 460 may transmit updated software change information to the continuous impact monitoring framework 450. Based on the change information, the continuous impact monitoring framework 450 may adjust data in the proposed software change data store 410 and the change may (or may not) be used in connection with the remote review device 470. Note that the continuous impact monitoring framework 450 and/or any of the other devices and methods described herein might be associated with a third party, such as a vendor that performs a service for an enterprise.

The continuous impact monitoring framework 450 and/or the other elements of the system 400 might be, for example, associated with a Personal Computer (“PC”), laptop computer, smartphone, an enterprise server, a server farm, and/or a database or similar storage devices. According to some embodiments, an “automated” continuous impact monitoring framework 450 (and/or other elements of the system 400) may facilitate the automated access and/or update of electronic records in the data store 410 and/or the management or reporting of forecast impacts. As used herein, the term “automated” may refer to, for example, actions that can be performed with little (or no) intervention by a human.

Devices, including those associated with the continuous impact monitoring framework 450 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The continuous impact monitoring framework 450 may store information into and/or retrieve information from the proposed software change data store 410, which may be locally stored or reside remote from the continuous impact monitoring framework 450. As will be described further, the proposed software change data store 410 may be used by the continuous impact monitoring framework 450 in connection with an interactive user interface to access and update electronic records. Although a single continuous impact monitoring framework 450 is shown in FIG. 4, any number of such devices may be included. Moreover, various devices described herein might be combined according to embodiments of the present invention. For example, in some embodiments, the continuous impact monitoring framework 450 and the proposed software change data store 410 might be co-located and/or may comprise a single apparatus.

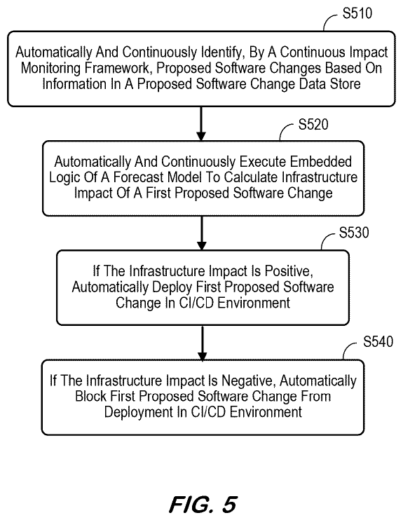

The elements of the system 400 may work together to perform the various embodiments of the present invention. Note that the system 400 of FIG. 4 is provided only as an example, and embodiments may be associated with additional or fewer elements or components. According to some embodiments, the elements of the system 400 automatically transmit information associated with an interactive user interface display over a distributed communication network. FIG. 5 is a method 500 that might be performed, for example, by the system 400 of FIG. 4 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S510, the system may automatically and continuously identify proposed software changes based on information in a proposed software change data store. At S520, embedded logic of a forecast model may be automatically and continuously executed to calculate an infrastructure impact of a first proposed software change. The forecast model might be associated with, for example, Artificial Intelligence (“AI”), Machine Learning (“ML”), a predictive model, etc.

If the infrastructure impact is positive, the system automatically deploys the first proposed software change in a cloud computing CI/CD environment at S530. The cloud computing environment might be associated with, for example, a suite of cloud computing services providing tools and services for computing, storage, data analytics, machine learning, etc. such as AMAZON WEB SERVICE™ (“AWS”), MICROSOFT™ AZUR®, GOOGLE™ CLOUD PLATFORM® (“GCP”), ALIBABA™ Cloud, etc. Some embodiments may utilize a “NeoCloud” cloud computing provider that focuses on offering Graphical Processing Unit (“GPU”) compute rental, particularly for AI workloads.

If the infrastructure impact is negative (that is, below some threshold value), the system automatically blocks the first proposed software change from deployment in the CI/CD environment at S540. In some embodiments, the system arranges for a review of the first proposed software change. If the infrastructure impact is negative and such review results in approval, the system may then automatically deploy the first proposed software change in the CI/CD environment. The arranged review might be associated with, for example, an automated or manual review. Moreover, the continuous impact monitoring framework may update the forecast model to adjust for changing conditions and improve performance.

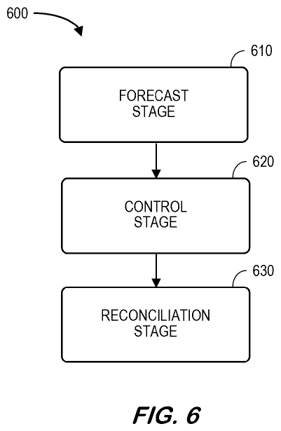

In this way, embodiments may introduce financial considerations as a technical component of cloud operations by integrating them into standard CI/CD pipelines. FIG. 6 is a pipeline 600 in accordance with some embodiments. Early in the lifecycle, changes to infrastructure-as-code are evaluated in a forecast stage 610 using embedded pricing logic. This logic may convert individual resources into their billable equivalents, enabling an accurate forecast of the financial impact of proposed changes. All forecasts can then be aggregated and visualized using analytical tools. On-demand, a control stage 620 can analyze the current live specifications across multiple monitored environments, applying theoretical pricing logic to generate a real-time view of infrastructure and its estimated monthly impacts. Since cloud pricing often involves variables like consumption-based impacts (e.g., network transfer and backup storage), perfect forecasting may be unattainable. However, a reconciliation stage 630 may use forecast data in a format comparable with actual invoices. This standardized comparison allows for validation (e.g., achieving under 10% forecast disparity as a Key Performance (“KPI”). Any significant discrepancies may trigger an investigation for process refinement. By pricing each resource to its smallest component, the system may enable precise attribution of impact fluctuations to individual changes down to the responsible pull request.

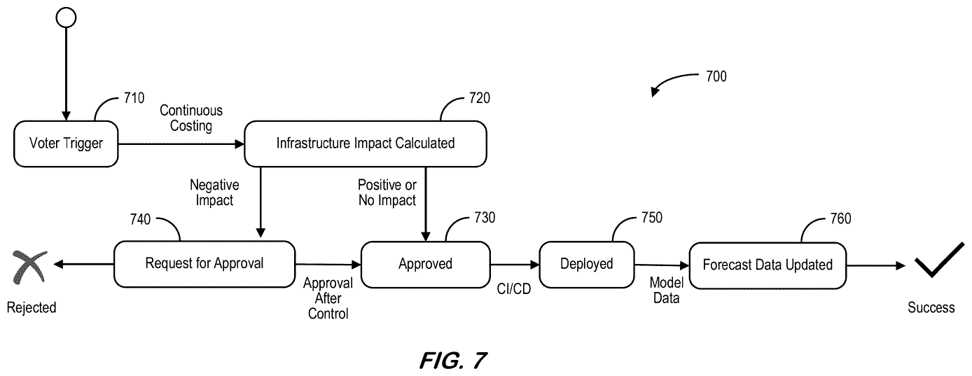

FIG. 7 is an infrastructure impact calculation 700 for CI/CD changes according to some embodiments. At 710, a voter trigger (e.g., submission of a proposed software change from a developer) initiates the process. At 720, an impact (e.g., to cloud provider costs) is calculated or estimated which may reflect a positive result and therefore result in approval 730. If the impact calculated at 720 instead reflects a negative result, this may result in a request for approval 740. If the request for approval 740 is rejected, the process ends. If the request for approval 730 is accepted, the software change is deployed 750 and the forecast model is updated 760.

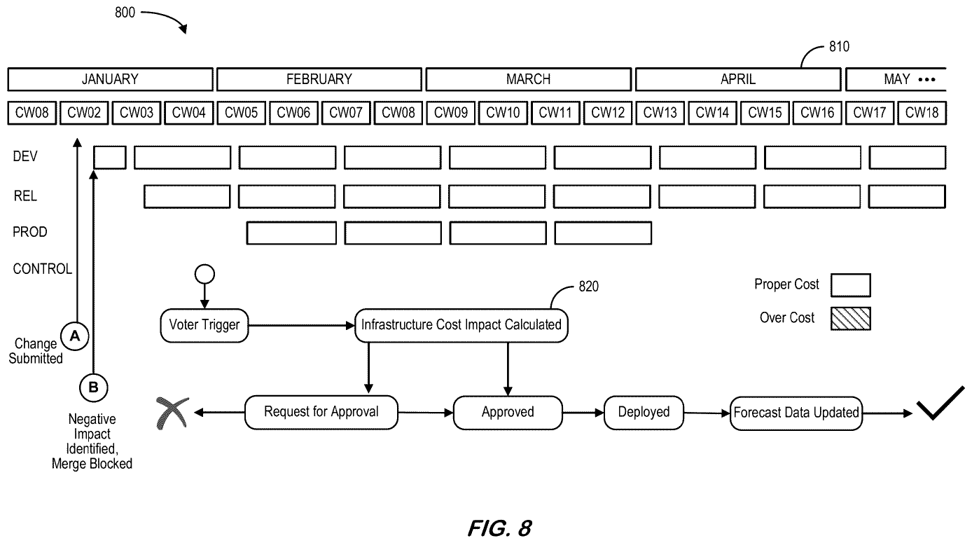

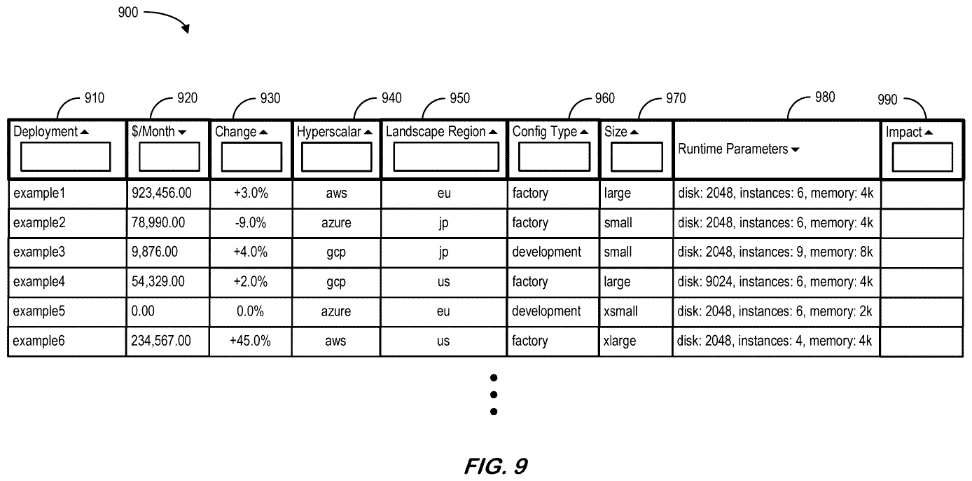

FIG. 8 illustrates a software change implemented in a CI/CD environment 800 in accordance with some embodiments. A multi-CW timeline 810 includes software development, release, production, and control processes. At (A), a potential software change is submitted by a developer. If an infrastructure impact calculation 820 identifies a negative impact, the merge is blocked at (B). As a result, over cost charges may be avoided. FIG. 9 is a control stage table 900 according to some embodiments. The table 900 includes information about software deployment 910, monthly charges 920, a change percentage 930, a hyperscalar identifier 940, a landscape religion 950 (e.g., country), a configuration type 960, a size (e.g., small or large) 970, runtime parameters 980, an impact 990, etc.

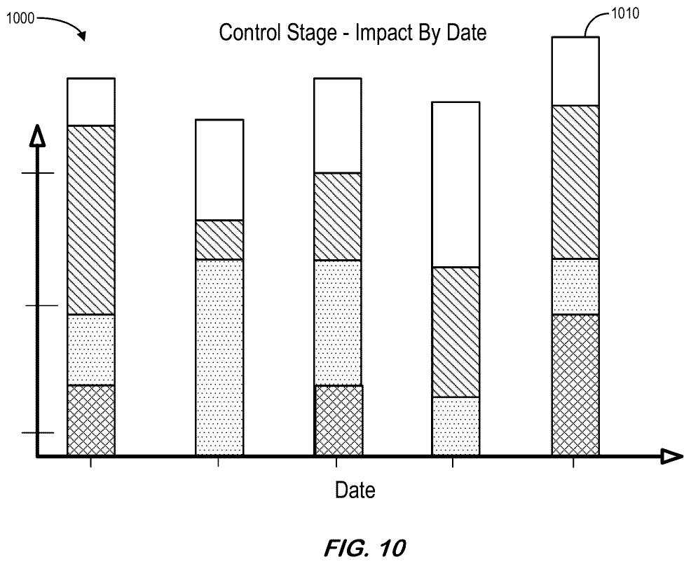

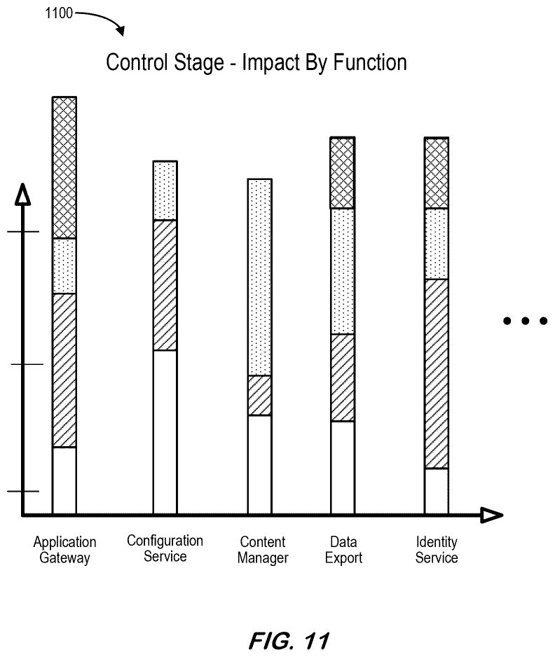

FIG. 10 is a control stage chart 1000 breaking down costs based on time periods in accordance with some embodiments. The different crosshatches 1010 may reflect cloud costs, caching costs (for an open-source, in-memory data structure store that can be used as a database, cache, message broker, etc.), database costs (for an open-source relational database management system providing extensibility and Structured Query Language (“SQL”) compliance), observability costs (for an observability platform that monitors, analyzes, and optimizes application performance), runtime costs, etc. Similarly, FIG. 11 is a control stage function chart 1100 breaking down costs based on functionality according to some embodiments.

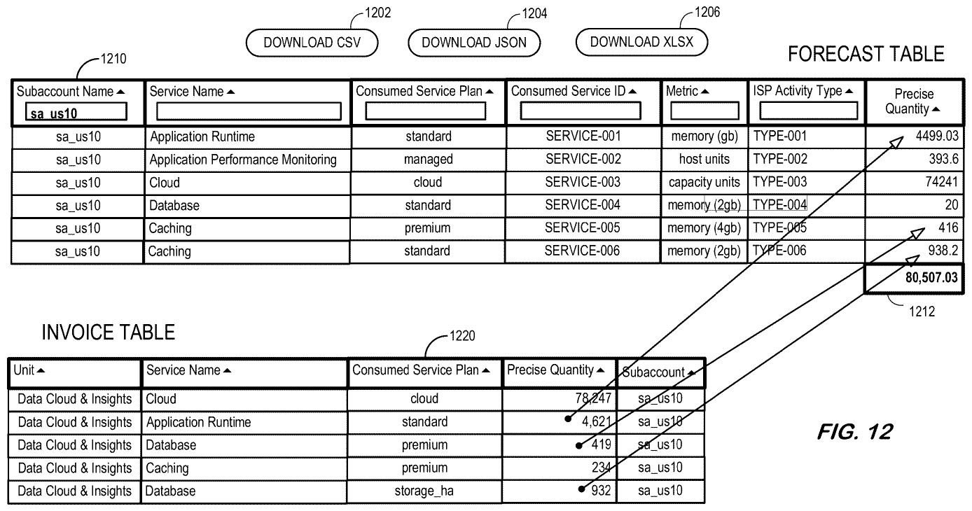

FIG. 12 includes reconciliation stage tables 1210, 1220 that may be used to generate a billing report (e.g., by billable type and/or landscape) to be downloaded in Comma Separated Value (“CSV”) 1202, Java Script Object Notation (“JSON”) 1204, EXCEL® Extensible Markup Language (“XLSX”) 1206, etc. in accordance with some embodiments. In particular, a forecast table 1210 that includes a sub account name, a service name, a consumed service plan, a consumed service identifier, a metric, an Internet Service Provider (“ISP”) activity type, a precise quantity, a total cost 1212, etc. An invoice table 1220 may include a unit identifier, a service name identifier, a consumed service plan, a precise quantity, a sub account identifier, etc. The tables 1210, 1220 can then be used to compare forecast impacts with actual results.

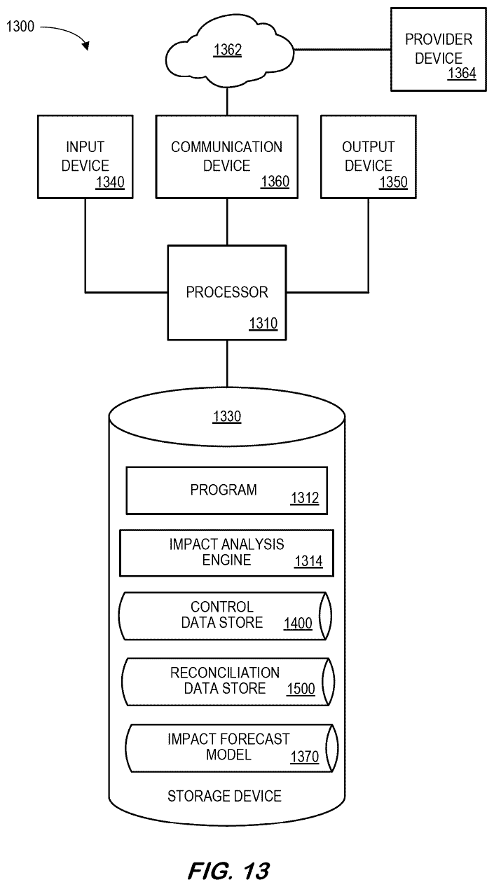

Note that the embodiments described herein may be implemented using any number of different hardware configurations. For example, FIG. 13 is a block diagram of an apparatus or platform 1300 that may be, for example, associated with the system 400 of FIG. 4 (and/or any other system described herein). The platform 1300 comprises a processor 1310, such as one or more commercially available Central Processing Units (“CPUs”) in the form of one-chip microprocessors, coupled to a communication device 1360 configured to communicate via a communication network 1362. The communication device 1360 may be used to communicate, for example, with one or more provider devices 1364, developer devices, administrator platforms, etc. The platform 1300 further includes an input device 1340 (e.g., a computer mouse and/or keyboard to input data mappings and/or threshold values) and/or an output device 1350 (e.g., a computer monitor to render a display, transmit recommendations and alerts, and/or create reports about change impacts, feedback to improve system performance, etc.).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or an impact analysis engine 1314 for controlling the processor 1310. The processor 1310 performs instructions of the programs 1312, 1314, and thereby operates in accordance with any of the embodiments described herein. For example, the processor 1310 may automatically and continuously identify proposed software changes based on information in the proposed software change data store. The processor 1310 also automatically and continuously executes the embedded logic to calculate an infrastructure impact of a first proposed software change. If the infrastructure impact is positive, the processor 1310 may automatically deploy the first proposed software change in the CI/CD environment. If the infrastructure impact is negative, the processor 1310 may automatically block the first proposed software change from deployment in the CI/CD environment. In some embodiments.

The programs 1312, 1314 may be stored in a compressed, uncompiled and/or encrypted format. The programs 1312, 1314 may furthermore include other program elements, such as an operating system, clipboard application, a database management system, and/or device drivers used by the processor 1310 to interface with peripheral devices.

As used herein, information may be “received” by or “transmitted” to, for example: (i) the platform 1300 from another device; or (ii) a software application or module within the platform 1300 from another software application, module, or any other source.

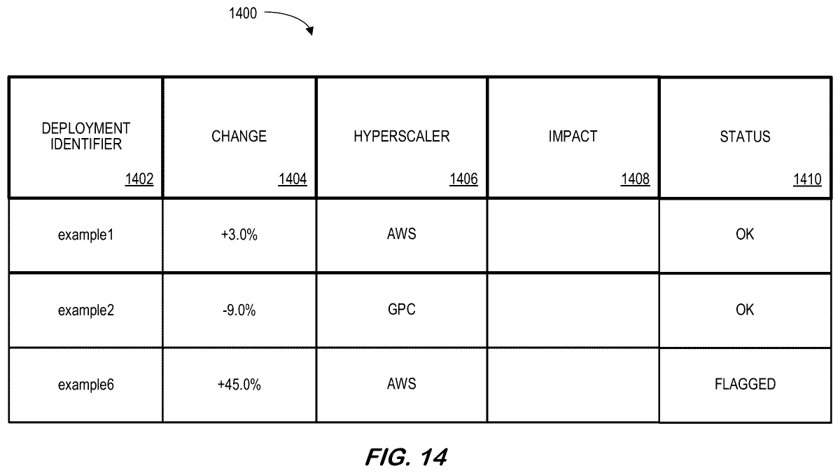

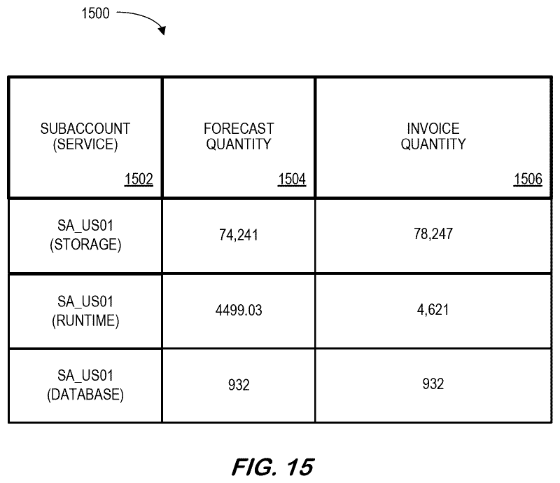

In some embodiments (such as the one shown in FIG. 13), the storage device 1330 further stores a control data store 1400, a reconciliation data store 1500, and an impact forecast model 1370. Examples of databases that may be used in connection with the platform 1300 will now be described in detail with respect to FIGS. 14 and 15. Note that the databases described herein are only examples, and additional and/or different information may be stored therein. Moreover, various databases might be split or combined in accordance with any of the embodiments described herein.

Referring to FIG. 14, a table is shown that represents the control data store 1400 that may be stored at the platform 1300 according to some embodiments. The table may include, for example, entries identifying deployed software being changed by a developer. The table may also define fields 1402, 1404, 1406, 1408, 1410 for each of the entries. The fields 1402, 1404, 1406, 1408, 1410 may, according to some embodiments, specify: a deployment identifier 1402, a change 1404, a hyperscalar identifier 1406, an impact 1408, and a status 1410. The control data store 1400 may be created and updated, for example, when a new change is identified, results are updated by the system, etc.

The deployment identifier 1402 might be a unique alphanumeric label that is associated with the software that is being updated. The change 1404 might indicate a predicted percentage value change in service provider cost. The hyperscalar identifier 1406 may indicate a cloud service provider, and the impact 1408 might indicate a forecast cost change (e.g., a dollar amount). The status 1410 might indicate that the change is approved (“OK”) or rejected (flagged”).

Referring to FIG. 15, a table is shown that represents the reconciliation data store 1500 that may be stored at the platform 1300 according to some embodiments. The table may include, for example, entries identifying account information associated with an enterprise. The table may also define fields 1502, 1504, 1506 for each of the entries. The fields 1502, 1504, 1506 may, according to some embodiments, specify: a subaccount and service 1502, a forecast quantity 1504, and an invoice quantity 1506. The reconciliation data store 1500 may be created and updated, for example, when a new invoice is received, results are updated by the system, etc. The subaccount and service 1502 might be unique alphanumeric labels that are associated with a cloud service provider. The forecast quantity 1504 may indicate a predicted value which can then be compared to the actual invoice quantity 1506.

In this way, embodiments may facilitate proactive impact control so that early-stage forecasting can provide immediate alerts for problematic changes (enabling review and mitigation before deployment). Embodiments may also facilitate enhanced impact awareness using embedded pricing logic to equip developers and managers with clear insights into the resource impacts under their control.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

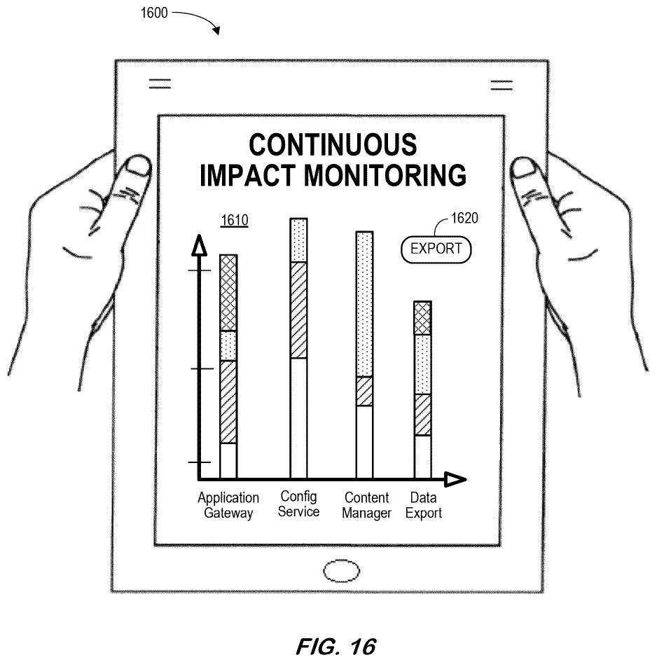

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of software applications, any of the embodiments described herein could be applied to other types of software applications. Moreover, the displays shown herein are provided only as examples, and any other type of user interface could be implemented. For example, FIG. 16 illustrates a tablet computer 1600 providing a continuous import monitoring display 1610 including costs broken down by function, etc. The display 1610 might be used, for example, to export information using an “Export” icon 1620.

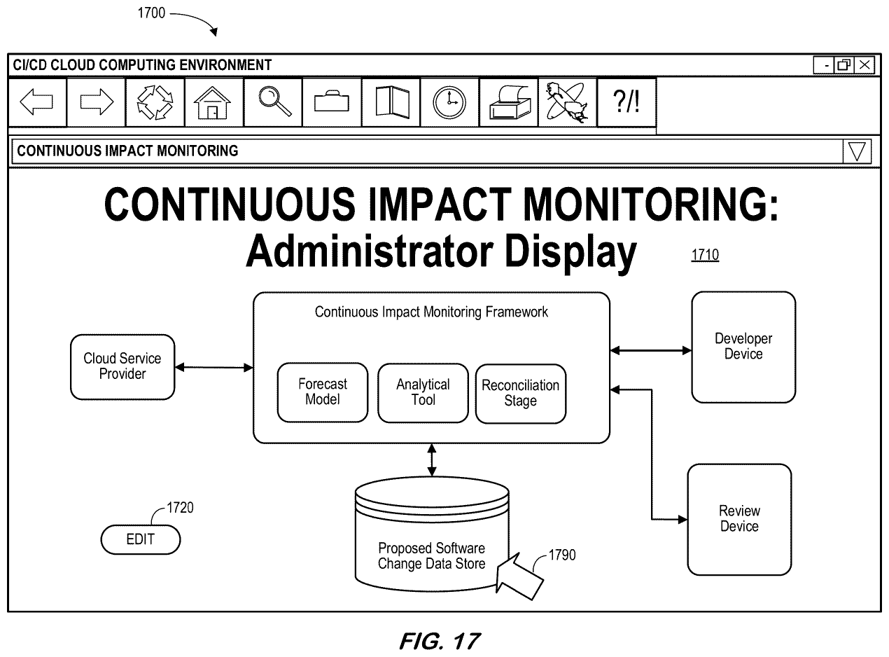

FIG. 17 is an operator or administrator display in accordance with some embodiments. The display 1700 includes a graphical representation 1710 of a continuous impact monitoring framework in accordance with any of the embodiments described herein. Selection of an element on the display 1700 (e.g., via a touchscreen or computer pointer 1790) may result in display of a pop-up window containing more detailed information about that element and/or various options (e.g., customized threshold details, mappings to databases, result report summaries, etc.). Selection of an “Edit” icon 1720 may also let an operator or administrator adjust the operation of the system (e.g., to change system mappings, adjust threshold rules or logic, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system for a cloud computing Continuous Integration and Continuous Deployment (“CI/CD”) environment, comprising:
a proposed software change data store containing electronic records associated with the CI/CD environment;
a forecast model with embedded logic that estimates an infrastructure impact;
a continuous impact monitoring framework, coupled to the proposed software change data store, including:
a computer processor, and
a computer memory storing instructions that, when executed by the computer processor, cause the continuous impact monitoring framework to perform the following steps:
automatically and continuously identify proposed software changes based on information in the proposed software change data store,
automatically and continuously execute the embedded logic to calculate an infrastructure impact of a first proposed software change,
if the infrastructure impact is positive, automatically deploy the first proposed software change in the CI/CD environment, and
if the infrastructure impact is negative, automatically block the first proposed software change from deployment in the CI/CD environment; and
a reconciliation data store containing forecast information and invoice information associated with the first proposed software change.

2. The system of claim 1, wherein the continuous impact monitoring framework is further to:
if the infrastructure impact is negative, arrange for a review of the first proposed software change and, if the review results in approval, automatically deploy the first proposed software change in the CI/CD environment.

3. The system of claim 2, wherein the arranged review is associated with at least one of: (i) an automated review, and (ii) a manual review.

4. The system of claim 1, wherein the forecast model is associated with at least one of: (i) Artificial Intelligence (“AI”), (ii) Machine Learning (“ML”), and (iii) a predictive model.

5. The system of claim 1, wherein the continuous impact monitoring framework includes a forecast stage that uses an analytical tool to convert individual resource impacts, aggregate results of the conversion, and generate a graphical visualization of the aggregated results.

6. The system of claim 1, wherein the continuous impact monitoring framework includes a control stage to analyze multiple monitored environments and generate a view of infrastructure impacts in substantially real-time.

7. The system of claim 1, wherein the continuous impact monitoring framework includes a reconciliation stage to validate forecasts based on a comparison with subsequent information from a cloud service provider.

8. The system of claim 7, wherein the continuous impact monitoring framework is used to update the forecast model.

9. A computer-implemented method for a cloud computing Continuous Integration and Continuous Deployment (“CI/CD”) environment, comprising:
automatically and continuously identifying, by a computer processor of a continuous impact monitoring framework, proposed software changes based on information in a proposed software change data store;
automatically and continuously executing embedded logic of a forecast model to calculate an infrastructure impact of a first proposed software change;
if the infrastructure impact is positive, automatically deploying the first proposed software change in the CI/CD environment;
if the infrastructure impact is negative, automatically blocking the first proposed software change from deployment in the CI/CD environment; and
if the infrastructure impact is negative, arranging for a review of the first proposed software change and, if the review results in approval, automatically deploying the first proposed software change in the CI/CD environment.

10. The method of claim 9, wherein the arranged review is associated with at least one of: (i) an automated review, and (ii) a manual review.

11. The method of claim 9, wherein the forecast model is associated with at least one of: (i) Artificial Intelligence (“AI”), (ii) Machine Learning (“ML”), and (iii) a predictive model.

12. The method of claim 9, wherein the continuous impact monitoring framework includes a forecast stage that uses an analytical tool to convert individual resource impacts, aggregate results of the conversion, and generate a graphical visualization of the aggregated results.

13. The method of claim 9, wherein the continuous impact monitoring framework includes a control stage to analyze multiple monitored environments and generate a view of infrastructure impacts in substantially real-time.

14. The method of claim 9, wherein the continuous impact monitoring framework includes a reconciliation stage to validate forecasts based on a comparison with subsequent information from a cloud service provider.

15. The method of claim 14, wherein the continuous impact monitoring framework is used to update the forecast model.

16. One or more non-transitory computer-readable media storing computer-executable instructions that, when executed by a computing system, cause the computing system to perform operations for a cloud computing Continuous Integration and Continuous Deployment (“CI/CD”) environment comprising:
automatically and continuously identifying, by a computer processor of a continuous impact monitoring framework, proposed software changes based on information in a proposed software change data store;
automatically and continuously executing embedded logic of a forecast model to calculate an infrastructure impact of a first proposed software change;
converting, by an analytic tool of a forecast stage, individual resource impacts, aggregating results of the conversion, and generating a graphical visualization of the aggregated results;
analyzing, by a control stage multiple monitored environments and generating a view of infrastructure impacts in substantially real-time;
if the infrastructure impact is positive, automatically deploying the first proposed software change in the CI/CD environment;
if the infrastructure impact is negative, automatically blocking the first proposed software change from deployment in the CI/CD environment; and
validating, by a reconciliation stage, forecasts based on a comparison with subsequent information from a cloud service provider.

17. The media of claim 16, further comprising:
if the infrastructure impact is negative, arranging for a review of the first proposed software change and, if the review results in approval, automatically deploying the first proposed software change in the CI/CD environment.

18. The media of claim 17, wherein the arranged review is associated with at least one of: (i) an automated review, and (ii) a manual review.

19. The media of claim 16, wherein the forecast model is associated with at least one of: (i) Artificial Intelligence (“AI”), (ii) Machine Learning (“ML”), and (iii) a predictive model.

20. The media of claim 16, wherein the continuous impact monitoring framework is used to update the forecast model.
